(19) United States
(12) Patent Application Publication
(10) Pub. No.: US 2014/0234066 A1
(43) Pub. Date: Aug. 21, 2014

(54) PICKING SYSTEM HAVING AN ARTICULATED ARM GRIPPER

(71) Applicants: Franz Mathi, Gleisdorf (AT); Florian Hoffmann, Unterpremstatten (AT)

(72) Inventors: Franz Mathi, Gleisdorf (AT); Florian Hoffmann, Unterpremstatten (AT)

(73) Assignee: Knapp AG, Hart bei Graz (AT)

(21) Appl. No.: 14/117,510

(22) PCT Filed: May 15, 2012
(86) PCT No.: PCT/EP12/58971

§ 371 Date: Nov. 13, 2013

(30) Foreign Application Priority Data
May 30, 2011 (AT) A 786/2011

(51) Int. Cl. B65G 47/91; B65G 47/90

(52) U.S. Cl. CPC B65G 47/917; B65G 47/90
USPC 414/752.1; 414/751.1

(57) ABSTRACT

A picking system for the automated picking of articles, comprising a detection station for detecting the position of an article to be picked on a supplying conveyor, and an articulated arm gripper for picking up the article from the storage loading implement from the supplying conveyor and for depositing the article in the order loading implement on a discharge conveyor. The articulated arm gripper comprises an essentially upright longitudinal arm and an articulated arm which can be bent about an angle of articulation and on which a gripping device for gripping the article is provided. The articulated arm gripper is designed for picking up the at least one article to be picked from a storage loading implement which is transported on the supplying conveyor. The longitudinal arm of the articulated arm gripper is at least twice as long as the articulated arm.

### BACKGROUND OF THE INVENTION

1. Field of the Invention

The invention relates to a picking system for the automated picking of articles, comprising a detection station for detecting the position of an article to be picked on a supplying conveyor unit and comprising an articulated arm gripper for picking up the article from a storage loading implement from the supplying conveyor unit and for depositing the article in an order loading implement on a discharge unit, wherein the articulated arm gripper can be positioned by a kinematic unit of the picking system within an operational range of the kinematic unit and wherein the articulated arm gripper comprises an essentially upright longitudinal arm and an articulated arm which can be bent about an angle of articulation and on which a gripping device for gripping the article is provided.

2. Description of the Related Art

Document EP 1 160 166 B1 discloses a sorting system wherein articles are supplied in the form of food slices on a first conveyor belt to two robots by means of which the food slices are sorted into a package on a second conveyor belt. The robots comprise a kinematic unit which, based on a so-called delta kinematics, is formed with three delta arms. On the kinematic unit, a gripper is mounted by means of which one food slice at a time is picked up from the first conveyor belt by a vacuum gripper and is deposited onto an oblique surface into a package on the second conveyor belt. For this purpose, the gripper comprises an arm which is attached to a longitudinal arm and is bent about a particular angle which, at one point, has been adjusted.

An optical detection station comprises a detection cone which is directed at the first conveyor belt and detects the position of the food slices on the conveyor belt. Said position information is transmitted to a control device of the sorting system, which actuates the two robots. For picking up a food slice, the kinematic system positions the gripper directly above the food slice on the first conveyor belt and the vacuum gripper applies suction to the food slice. For depositing the food slice, the control device positions the gripper with the food slice that has been picked up over a free position of the package. During the positioning of the gripper from the first conveyor belt to the second conveyor belt, an angle of rotation of the gripper about the longitudinal arm of the articulated arm gripper is thereby adjusted from a first angle of rotation when the food slice is being picked up, which angle is always the same, into a second angle of rotation for releasing the food slice, which angle is always the same. Subsequently, the vacuum gripper releases the food slice into the package. During the construction of the picking system, the arm's angle of articulation was once adjusted to the location of the supplying conveyor unit and the discharge unit.

The known sorting system has turned out to have the drawback that, with the gripper, articles can only be picked up from the flat first conveyor belt and deposited in the flat package on the second conveyor belt. The supply of the food slices on the first conveyor belt does not happen from storage loading implements, but said slices are supplied to the robots in an isolated manner. The situation is different with articles to be picked from an order picking warehouse, wherein, in most cases, the articles are stored in particular storage loading implements. This leads to different requirements for the kinematic unit and in particular for the articulated arm gripper which are not fulfilled by the known gripper.

### SUMMARY OF THE INVENTION

The present invention is based on the problem of providing an automated picking system with an articulated arm gripper, wherein the previously mentioned disadvantages are avoided. According to the invention, this problem is solved in that the articulated arm gripper is designed for picking up the article to be picked from storage loading implements which are transported on the supplying conveyor, wherein the longitudinal arm of the articulated arm gripper is at least twice and in particular at least five times as long as the articulated arm of the articulated arm gripper, and that the detection station is designed for detecting the three-dimensional position of the article in the storage loading implement and that the angle of articulation of the articulated arm and an angle of rotation of the articulated arm gripper are freely adjustable about the longitudinal arm, depending on the detected position for gripping the article.

In this way, the advantage is achieved that the articulated arm can also grip articles from a storage loading implement which optionally are positioned in a strongly inclined and/or hard-to-reach manner. Articles in a storage loading implement are strongly inclined particularly if a planar article surface is inclined toward the horizontal and optionally collides with the wall of the loading implement. Articles in a storage loading implement are hard to reach particularly if they are located in one of the corners of the storage loading implement or if they are located, partly covered, under other articles in the form of a bulk material of optionally different articles.

Via the three-dimensional detection of the position of the article to be picked in the storage loading implement and via the free adjustability of the angle of articulation and the angle of rotation of the articulated arm in combination with the relatively long longitudinal arm and the short articulated arm, the articulated arm gripper can be adjusted and positioned in precisely such a way that also articles to be picked which are difficult to access in the storage loading implement can be picked up with maximum gripping force and precision.

When the gripping device is designed as a vacuum gripper, it has turned out to be beneficial to apply suction to the article with the vacuum gripper and to prop it up against at least two and particularly advantageously against at least three supports. In this way, it is avoided that the article swings or even falls from the vacuum gripper when the kinematic unit is accelerated during gripping. It is particularly advantageous to adjust the support points depending on the article size or the article weight in order to obtain a bearing surface within the support points which is as large as possible. For this purpose, the distance of the support points of the vacuum gripper can be adjusted electromechanically, or the entire gripper can be exchanged for a gripper with different support points at a gripper changing station as described hereinbelow.

Furthermore, it has turned out to be advantageous to place the articulated arm of the articulated arm gripper in a vertical position, i.e., in the direction of the longitudinal arm, either by gravity or, for example, by means of a retaining spring, immediately after the article has been gripped. In this way, the gripping device is able to secure the article which has been picked up considerably more firmly.

Depending on the spatial position which the article to be picked assumes in the storage loading implement and depending on from which position of the storage loading implement the article is to be picked up by the articulated arm gripper, different approach strategies and actuation runs, respectively, of the kinematic unit are advantageous for positioning the articulated arm gripper. If the article to be picked is hard to reach and/or difficult to access since the articulated arm gripper only has a relatively small space for gripping the article, it has turned out to be advantageous that the articulated arm gripper with the articulated arm placed vertically downward is brought by the kinematic unit into the position for picking up the article and that, only then, the articulated arm is adjusted to the angle of articulation as predetermined by the control device. On the other hand, an article which is readily accessible in the storage loading implement to be picked up can be picked up faster if the articulated arm of the articulated arm gripper is adjusted to the predetermined angle of articulation and angle of rotation already during the positioning operation by the kinematic unit.

Furthermore, it has turned out to be advantageous if articles to be picked for an order are, for the moment, deposited on an intermediate buffer platform by one or several storage loading implements, which are delivered on the supplying conveyor, and are poured jointly into the second order loading implement allocated to the order. In doing so, it is particularly advantageous to pick shock-sensitive articles to be picked or articles which, due to their size or their weight, are the first or, respectively, last ones to be placed in the order loading implement directly into the order loading implement by means of the articulated arm gripper. The other articles which are poured from the intermediate buffer platform into the order loading implement (first group) can be poured before or after the article picked directly into the order loading implement (second group).

In order to adapt the picking system for automated picking to different types of storage and order loading implements (e.g., different materials, dimensions, partitions within the loading implements), it is advantageous to provide a gripper changing station. The control device is thus able to deposit the articulated arm gripper attached to the kinematic unit at the gripper changing station using the kinematic unit, depending on the type of the storage loading implement or depending on the type of the order loading implement, and is able to actuate a mechanism which attaches another suitable articulated arm gripper from the gripper changing station to the kinematic unit. It is also possible to conduct only a change of articulated arm grippers which are already attached to the kinematic unit. For example, the control device could adjust the articulated arm gripper according to the type of the storage loading implement and of the order loading implement, as a function of the ratio of article dimension to loading implement dimension, using a revolver device.

### BRIEF DESCRIPTION OF THE DRAWINGS

Hereinbelow, further advantageous embodiments of the system according to the invention are explained in further detail on the basis of the figures.

FIG. 1 shows a picking system for the automated picking of articles.

FIG. 2 shows a kinematic unit including an articulated arm gripper of the picking system according to FIG. 1.

FIG. 3 shows on the left-hand side a virtually empty storage loading implement from the corner of which the articulated arm gripper according to FIG. 1 picks up an article. In FIG. 3, the functioning of an articulated arm gripper is illustrated on the right-hand side as a symbolized picture.

FIG. 4 shows storage loading implements in which articles to be picked are arranged differently.

FIG. 5 shows articles in a single-variety bulk-material arrangement.

FIG. 6 shows the articulated arm gripper of the picking system according to FIG. 1 in a side view and a front view.

FIG. 7 shows the articulated arm gripper of the picking system according to FIG. 1 in an oblique view.

FIG. 8 shows the different contact points of the supports of the articulated arm gripper on differently sized articles to be gripped.

FIG. 9 shows a picking system for automated picking with an intermediate buffer platform.

FIG. 10 shows further embodiments of storage loading implements.

FIG. 11 shows a gripper according to the prior art.

### DETAILED DESCRIPTION OF THE PREFERRED EMBODIMENTS

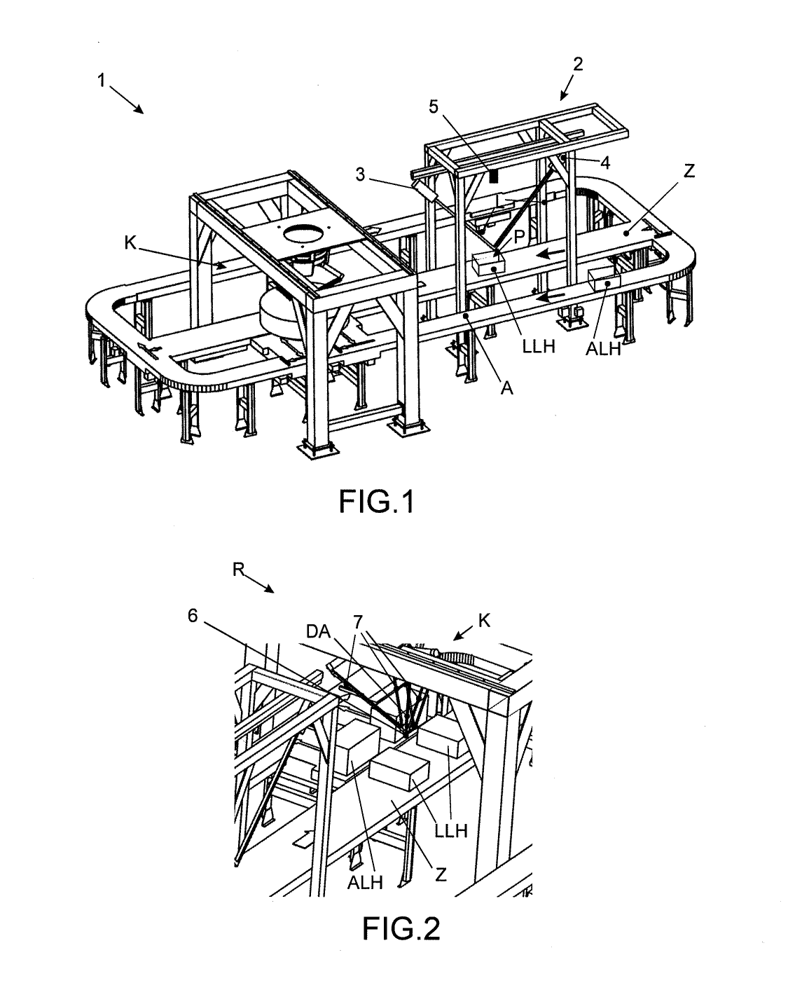

FIG. 1 shows a picking system 1 for the automated picking of articles P. The picking system 1 comprises a detection station 2 for detecting the location of the articles P to be picked. The detection station 2 is formed by a combination of sensors including an associated object identification software which is executed by a control computer, which is not illustrated in FIG. 1. Such a detection station 2 is already known from the prior art, for which reason this is not addressed in further detail. However, it should be mentioned that, via the detection station 2, not only the position of the article P (its coordinates), but also the spatial orientation thereof, that is, its location (e.g., the angles of its surfaces in a spatial coordinate system), is detected.

In a storage of the picking system 1, which is not illustrated in further detail in FIG. 1, the articles to be picked are stored in storage loading implements LLH of various dimensions, shapes and weights. Depending on the type of article or the type of storage, the storage loading implements LLH can have different ratios of base area to number of side walls and height. The control computer compiles picking orders according to incoming customer orders. According to the order control, a materials handling equipment conveys the storage loading implements LLH of the articles P to be picked from the automated storage and transports them to a supplying conveyor Z which is formed by a conventional conveyor belt. For the time being, the supplying conveyor Z transports the storage loading implements LLH through the detection station 2 and then to a kinematic unit K which picks up the corresponding number of articles P to be picked from the storage loading implement LLH and deposits them in the order loading implement ALH on a discharge conveyor A.

In FIG. 2, the kinematic unit K, the supplying conveyor Z with storage loading implements LLH and the discharge conveyor A with order loading implements ALH in the working room R are illustrated in further detail. The kinematic unit K is formed by a delta kinematics with three double arms 7 and a rotary arm DA and is actuated by the control computer in order to position an articulated arm gripper 6 attached to the kinematic unit K within the operational range of the kinematic unit K and to rotate the articulated arm gripper 6 about its own axis. Such a kinematic unit K is known, for example, from Document WO2005/051812 A1. According to another exemplary embodiment of the invention, it would also be possible to implement the kinematic unit K by any type of industrial robot on which the articulated arm gripper 6 would be attached.

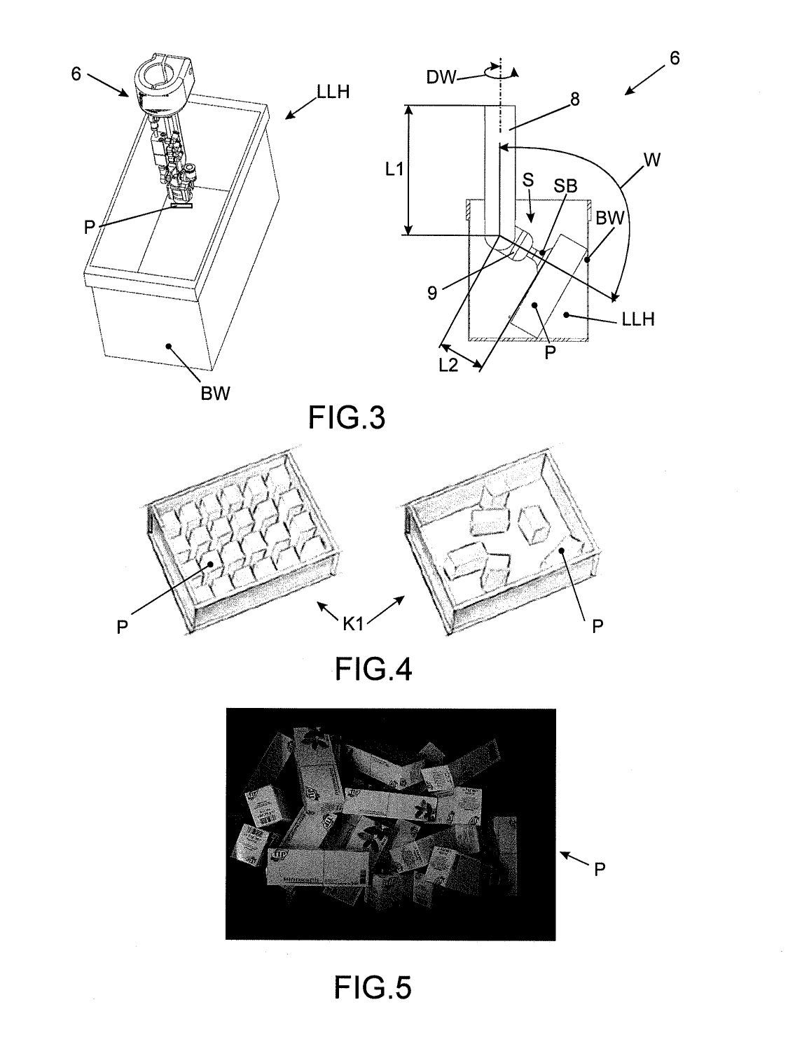

In FIG. 3 on the right-hand side, the functioning of the articulated arm gripper 6 is illustrated as a symbolized picture. The articulated arm gripper 6 comprises a longitudinal arm 8, which is essentially upright in the operating position, and an articulated arm 9, which can be bent about an angle of articulation W. By means of the rotary arm DA of the kinematic unit K, the articulated arm gripper 6 can be twisted continuously about the axis of the longitudinal arm 8 into an angle of rotation DW present by the control computer. The articulated arm gripper 6 comprises a vacuum gripper S with a suction bellows SB as a gripping device for gripping articles P. For picking up the article P, a pneumatic device, which is not illustrated any further in the figures, applies suction to the article to be picked via a negative pressure in the suction bellows SB, while being controlled by the control computer. For releasing the article P, the negative pressure is compensated for, whereupon the sucked article is released by the suction bellows SB.

Furthermore, in FIG. 3 on the right-hand side, an article P is illustrated which is positioned obliquely at the container wall BW of the storage loading implement LLH. Due to the ratio between a small container base area and a large container wall height, the articulated arm gripper 6 comprises a longitudinal arm 8 the length L1 of which is three times as long as the length L2 of the articulated arm 9. In this way, it is advantageously achieved that articles P can be picked up with the kinematic unit K also from small storage loading implements LLH and picked into the order loading implements ALH. In doing so, it is particularly advantageous that the detection station 2 detects not only the position of the article P in the storage loading implement LLH, but also the three-dimensional location thereof. In this manner, the angle of articulation W and the angle of rotation DW can be adjusted by the control computer in such a way that the articulated arm 9 is placed vertically on the surface of the article P to which the vacuum gripper S is applied. For this reason, the article P can be picked up from the storage loading implement LLH and held firmly with a maximum suction power despite a small suction bellows SB.

Depending on the type of loading implement, the longitudinal arm may also be designed so as to be five times or twenty times as long as the articulated arm in order to reliably reach all gripping points in the storage loading implement LLH and to pick up the article P reliably even in case of inaccessible locations of the article P to be picked. In FIG. 3 on the left-hand side, a storage loading implement LLH with a high container wall BW is illustrated from the corner of which the articulated arm gripper 6 picks up a final article P. Based on the left-hand side of this FIG. 3, it is evident how small the required space is with which the articulated arm gripper 6 can remove articles P from the storage loading implements LLH. In order to illustrate this even better, a conventional gripper 20 according to the prior art is depicted in FIG. 11. By way of this FIG. 11, the problem of gripping the product P on its surface 21 with such a gripper 20 in a narrow storage loading implement LLH is directly obvious.

In FIG. 4 on the left-hand side, a storage loading implement LLH is illustrated in which articles P to be picked are arranged side by side in a sorted fashion. In FIG. 4 on the right-hand side, a different situation is illustrated in which articles P to be picked are arranged as a bulk material. In practice, mixed forms of sorted articles P and bulk-material arrangements occur as well. In FIG. 5, a single-variety bulk-material situation of articles P is illustrated, wherein the spatial position of said articles is identified by the detection station 2 so that the articulated arm gripper 6 can firmly grip one or several of those articles P and pick them into one of the order loading containers LLH.

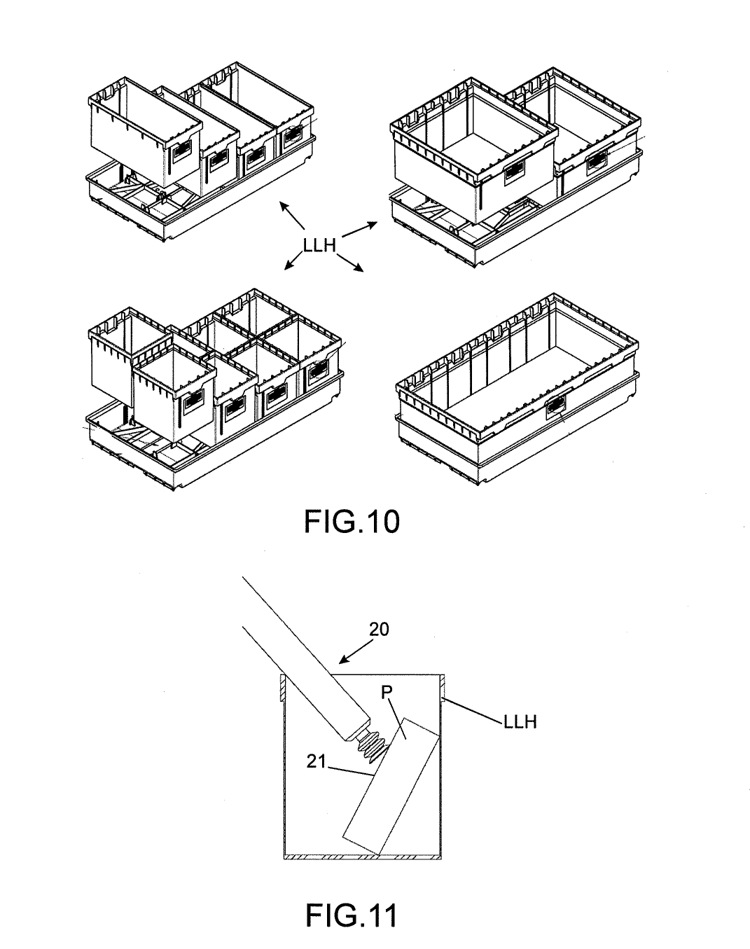

In FIG. 10, four further examples of storage loading implements LLH are illustrated, wherein a different number of smaller storage loading implement containers are accommodated in a bottom of the storage loading implement LLH. In those different storage loading implements LLH, articles in different amounts and sizes can be stored efficiently. By means of the articulated arm gripper 6, articles can also be gripped properly and firmly and picked from the small storage loading implement containers.

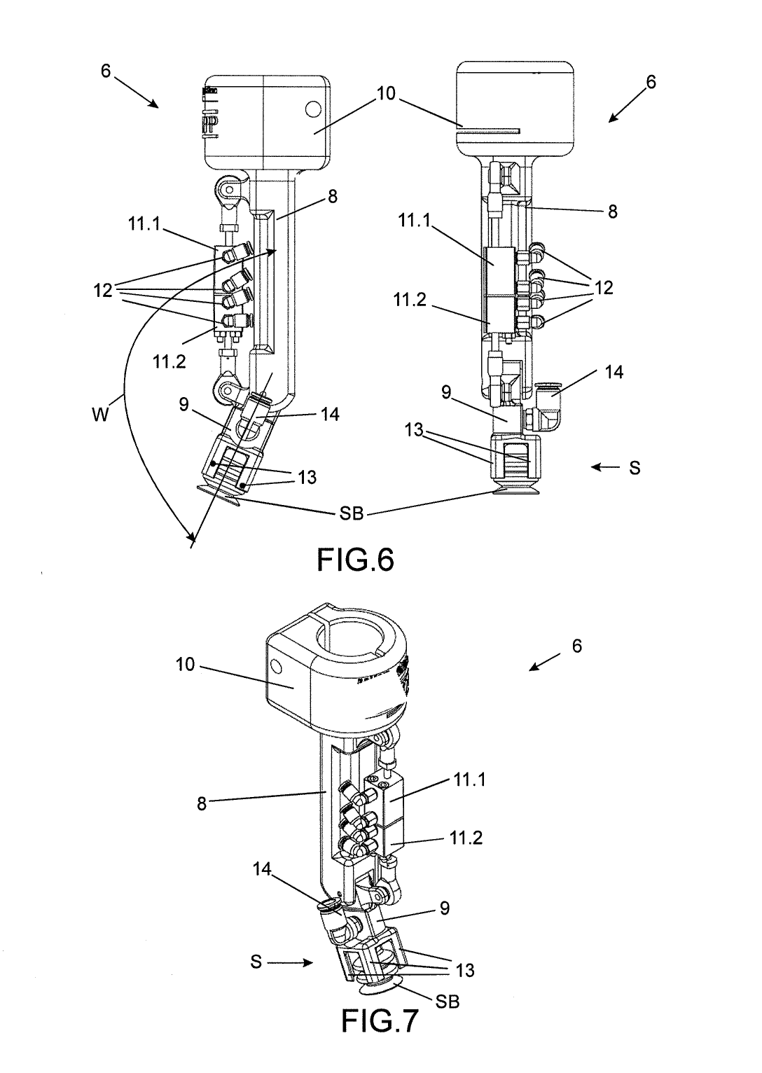

FIG. 6 shows the articulated arm gripper 6 of the picking system 1 according to FIG. 1 in a side view and a front view. In FIG. 7, the articulated arm gripper 6 is illustrated in an oblique view. The articulated arm gripper 6 comprises a holding device 10 via which the articulated arm gripper 6 is attached to the kinematic unit K. Said holding device 10 is implemented such that a mechanism of the kinematic unit K, which is not illustrated in further detail, can release and also reattach the holding device 10 via a control command of the control computer. This is necessary because the kinematic unit K of the picking system 1 is equipped with a gripper changing station with different articulated arm grippers, which gripper changing station is not illustrated any further in the figures. Depending on the type of the storage loading implement and of the article P to be picked therein on the supplying conveyor Z, the kinematic unit K can be moved to the gripper changing station while being controlled by the control computer in order to release there the articulated arm gripper 6, which is attached to the kinematic unit K, from the kinematic unit K and to attach another articulated arm gripper, which is available at the gripper changing station, to the kinematic unit K. The articulated arm grippers 6 at the gripper changing station may have different length ratios of the longitudinal arm 8 to the articulated arm 9, may be designed narrower or wider or, however, may also exhibit the required stability for carrying larger loads. In this way, the advantage is achieved that the kinematic unit K including the articulated arm gripper 6 is adaptable, in operation during the picking process, to different article sizes as well as storage loading implements in an automated way.

It may be mentioned that the gripper changing station might also be implemented in such a way that two or several grippers are attached directly to the kinematic unit K. For example, they might be attached to the kinematic unit K by means of a revolver fixture, wherein one of those grippers at a time would be rotated into the operating position and would be actuated by the control computer for gripping articles P.

Furthermore, in FIGS. 6 and 7, two pneumatic cylinders 11.1 and 11.2 are illustrated in parallel to the longitudinal arm 8. The angle of articulation W of the longitudinal arm 8 is adjusted to the articulated arm 9 via the respective compressed-air supplies 12 by means of the pneumatic cylinders 11.1 and 11.2, wherein this is controlled by the control computer. Furthermore, the articulated arm 9 comprises four supports 13 which directly surround the suction bellows SB of the vacuum gripper S. For picking up an article P, the suction bellows SB is charged with a negative pressure via a negative pressure port 14. As a result, the suction bellows SB contracts and the article P is pressed against the four supports 13. In this position, the article P is held particularly firmly and reliably by the suction gripper S and will not start to swing even in case of abrupt accelerations or decelerations by the kinematic unit K.

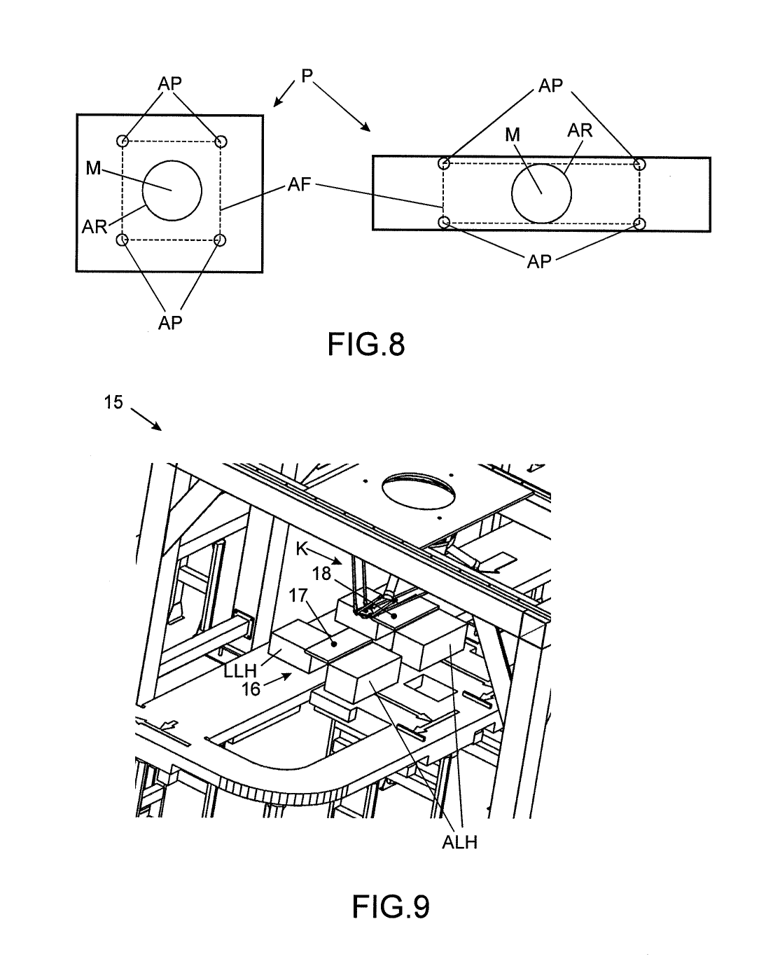

In FIG. 8 on the left-hand side, a square surface of the package of an article P is illustrated. After the precise location of an article P has been determined by the detection unit 2, the control computer determines the article P in the storage loading implement LLH which can be picked up with most ease by the articulated arm gripper 6 and on which surface of the article P the vacuum gripper S can be applied best. As soon as the surface has been determined, the centroid of said surface is determined and the control computer actuates both the kinematic unit K and the articulated arm gripper 6 in such a way that the centre M of the bearing ring AR of the suction bellows SB is applied to the centroid of the selected surface.

The angle of articulation W and the angle of rotation DW of the articulated arm gripper 6 about the longitudinal arm 8 thereof are thereby adjusted such that the articulated arm 9 is precisely vertical to the selected surface. In doing so, the supports 13 abut against the surface of the package at the support points AP. The larger the supporting surface AF on the surface of the article P as determined by the support points AP, the more reliably is the article P held by the vacuum gripper S. In this way, the article P can be picked up by the articulated arm gripper 6 with a maximum gripping force.

The control computer determines the control of the movement of the articulated arm gripper 6 by applying a collision prevention algorithm. When the articulated arm gripper 6 is brought close to the article P and the sucked article P is removed with the articulated arm gripper 6, the control computer thereby takes into account the dimensions of the bent articulated arm gripper 6 and of the sucked article P in order to avoid a collision with the container wall BW or the articles P remaining in the storage loading implement LLH.

Now it is particularly advantageous that the supports 13 of the articulated arm gripper 6 are designed so as to be adjustable. The distance between the supports 13 is determined by the control computer when it has been decided on which surface of the article P the vacuum gripper S will pick up the article P. In FIG. 8 on the right-hand side, an example of a rectangular surface of the package of an article P is illustrated. The control computer adjusts the supports 13 on the articulated arm gripper 6 in such a way that a supporting surface AF as large as possible will result. In this way, articles P can be picked up reliably also on the longitudinal side of their package. This adjustment of the supports 13 may be effected electromechanically or pneumatically, respectively, both continuously and in predetermined steps, or also by replacing the gripper at a gripper changing station.

Depending on how much space there is in the storage loading implement LLH filled with the articles P for picking up the article P to be picked which has been selected by the control computer (the control device), the control computer can move the vacuum gripper S to the selected surface of the article P according to different actuation runs. If there is relatively little space for the articulated arm gripper 6 for picking up the article P, since the article P is hard to reach, it has turned out to be advantageous if the kinematic unit K positions the articulated arm gripper 6 directly in front of the article P to be picked up, with the articulated arm 9 oriented in the direction of the longitudinal arm 8 (angle of articulation W=180 degrees). The articulated arm 9 is bent about the angle of articulation W present by the control computer only in this position of the articulated arm gripper 6 as a final positioning operation before suction is applied to the article P. In this way, the articulated arm gripper 6 can advantageously be positioned also in very inaccessible places in the storage loading implement LLH for picking up an article P.

However, if the article P in the storage loading implement LLH is freely accessible for the articulated arm gripper 6, the time for picking the article P from the storage loading implement LLH into the order loading implement ALH can be reduced in that the articulated arm 9 is bent about the angle of articulation W already during the positioning of the articulated arm gripper 6 by the kinematic unit K. The angle of rotation can be adjusted to the angle of rotation DW already during the positioning of the articulated arm gripper 6 by the kinematic unit K independently of the selected actuation run, since the interfering contour of the articulated arm gripper 6 is thereby not enlarged. As a result of this chronologically parallel adjustment of the kinematic unit K and of the articulated arm gripper 6, the throughput of the picking system 1 can be increased and the picking system 1 can thus be made more economical.

In FIG. 9, a picking system 15 with an intermediate buffer platform 16 as an intermediate buffer is now illustrated, on which articles P to be picked for 1 to n different orders can be intermediately buffered on 1 to n buffer units 17 and 18. The articles P picked up by the kinematic unit K from the respective storage loading implements LLH are deposited on the buffer unit 17 or 18 associated to the order. When all articles P to be picked for the order or parts thereof, respectively, lie on the buffer unit 17 or 18, the control computer actuates a mechanism which dumps the articles P of the tilting surface 17 or 18 into the order loading implements ALH allocated to the order. In this manner, an extensive decoupling of the picking up of articles P from the storage loading implements LLH and the release of articles P that have been picked up into the order loading implements ALH is achieved.

It may be mentioned that, for example, a platform with a pushing device, a plate which is pulled away from under the articles P, a funnel-shaped chute including a flap control or a sliding device including a flap control might also serve as an intermediate buffer. Furthermore, the number of two intermediate buffers is to be understood only as exemplary, since any number of intermediate buffers might be provided for shortly depositing articles P to be picked. It has turned out to be particularly advantageous if individual shock-sensitive articles P to be picked or articles P which, due to their size or their weight, are the first ones to be placed into the order loading implement ALH are picked by the articulated arm gripper 6 directly into the order loading implement ALH. The other articles P poured from the intermediate buffer platform 16 into the order loading implement ALH (first group) can be poured into the order loading implement ALH before or after the article P picked directly into the order loading implement ALH (second group).

It may be mentioned that the joint of the articulated arm gripper can be designed as a ball joint, as an integral hinge or also according to another type of joint.

The actuating elements of the articulated arm gripper can be designed pneumatically, hydraulically with single- or also double-acting cylinders. Likewise, it would be possible to ensure the actuation of the articulated arm from a remote servomotor via a cable pull or a rod assembly. Furthermore, sensors might be provided on the articulated arm gripper which monitor both the swivelling movement and the gripping function.

It may be mentioned that the gripper might be formed also by another type of gripper. For example, a clamping gripper might be provided which removes the articles P from the storage loading implement by a frictional connection.

It may be mentioned that more than one article at a time could also be picked with the gripper.

It may be mentioned that the kinematic unit might be implemented by a delta kinematics, but also by a robot arm or another mechanism known to a person skilled in this field.

1. A picking system for the automated picking of articles comprising a detection station for detecting the position of an article to be picked on a supplying conveyor unit and comprising an articulated arm gripper for picking up the article from a storage loading implement from the supplying conveyor unit and for depositing the article in an order loading implement on a discharge unit, wherein the articulated arm gripper can be positioned by a kinematic unit of the picking system within an operational range of the kinematic unit and wherein the articulated arm gripper comprises an essentially upright longitudinal arm and an articulated arm which can be bent about an angle of articulation and on which a gripping device for gripping the article is provided,
wherein the articulated arm gripper is designed for picking up the at least one article to be picked from the storage loading implement which is transported on the supplying conveyor, wherein the longitudinal arm of the articulated arm gripper is at least twice as long and in particular at least five times as long as the articulated arm of the articulated arm gripper and wherein detection station is designed for detecting the three-dimensional position of the article in the storage loading implement and the angle of articulation of the articulated arm and an angle of rotation of the articulated arm gripper are freely adjustable about the longitudinal arm, depending on the detected position for gripping the article.

2. A picking system according to claim 1, characterized in that the gripping device is formed by a vacuum gripper which comprises at least two or in particular three supports arranged around a suction bellows in order to apply suction to the article on a planar surface of the article, the article being propped up at the supports.

3. A picking system according to claim 2, wherein the supports of the gripping device are designed so as to be adjustable with regard to their support points on the planar surface of the article.

4. A picking system according to claim 1, wherein a control device is provided for controlling the kinematic unit and the articulated arm gripper in accordance with the location of the article to be picked as detected by the detection station, characterized in that the control device is designed for adjusting the articulated arm, which has been bent about the angle of articulation for picking up the article, in the direction of the longitudinal arm immediately after the article has been picked up.

5. A picking system according to claim 4, wherein, depending on the location of the article to be picked in the storage loading implement as detected by the detection station, the control device is designed for actuating the articulated arm according to one of the following actuation runs:
bending the articulated arm only after the positioning of the articulated arm gripper by the kinematic unit immediately before the article is picked up, in case of articles which are hard to reach and/or difficult to access;
bending the articulated arm already during the positioning of the articulated arm gripper by the kinematic unit, in case of articles which are free to be reached and/or easy to access.

6. A picking system according to claim 1, wherein the articulated arm gripper is designed for releasing the article that has been picked up into an intermediate buffer, and wherein the intermediate buffer, which is controlled by the control device, is designed for releasing the at least one article, which is intermediately stored in the intermediate buffer, into the order loading implement.

7. A picking system according to claim 6, wherein the control device is designed for actuating the articulated arm gripper in order to deposit a first group of articles to be picked into the order loading implements on an intermediate butter platform as an intermediate buffer and to deposit a second group of articles to be picked into the order loading implements in the order loading implements directly by the articulated arm gripper.

8. A picking system according to claim 1, wherein a gripper changing station is provided at which at least one further articulated arm gripper with a different length ratio of longitudinal arm to articulated arm is provided and the control device is designed for changing the articulated arm gripper depending on the type of the storage loading implement used on the supplying conveyor or depending on the type of the order loading implement used on the discharging conveyor.

9. An articulated arm gripper for picking up an article from a supplying conveyor and for depositing the article on a discharging conveyor, wherein the articulated arm gripper comprises an essentially upright longitudinal arm and an articulated arm which can be bent about an angle of articulation, wherein the articulated arm gripper has the features according to claim 1.
